(19) United States
(12) Patent Application Publication
(10) Pub. No.: US 2020/0130045 A1
(43) Pub. Date: Apr. 30, 2020

(54) Method and Apparatus for Attaching Rib Wires of a Wire Wrap Screen

(71) Applicant: RGL Reservoir Management Inc., Calgary (CA)

(72) Inventors: David William Paul STANIER, Edmonton (CA); Herman HEUKELMAN, Edmonton (CA)

(73) Assignee: RGL Reservoir Management Inc., Calgary, AB (CA)

(21) Appl. No.: 16/606,407

(22) PCT Filed: Apr. 19, 2018
(86) PCT No.: PCT/CA2018/050468

§ 371 Date: Oct. 18, 2019

Related U.S. Application Data
(60) Provisional application No. 62/487,319, filed on Apr. 19, 2017.

(51) Int. Cl. B21F 27/12; B21F 27/18; B23K 31/02; E21B 43/08

(52) U.S. Cl. CPC B21F 27/124; B21F 27/18; B23K 2101/32; E21B 43/088; B23K 31/02

(57) ABSTRACT

A method and apparatus for providing rib wires of a wire wrap screen on a pipe comprises one or more straps adapted to receive a plurality of rib wires and to engage the pipe, at least one of the straps being adapted to align at least a portion of the rib wires generally parallel with the longitudinal axis of the pipe and generally equidistantly spaced apart over the circumference of the pipe. The pipe with rib wires, once secured with the straps, can then be introduced into a wire wrap machine to form the wire wrap screen over the rib wires.

### CROSS REFERENCE TO RELATED APPLICATION

The present application claims priority under the Paris Convention to U.S. Application No. 62/487,319, filed on Apr. 19, 2017, the entire contents of which are incorporated herein by reference.

### FIELD OF THE DESCRIPTION

The present description relates to wire screens used in subterranean wells. In particular, the description relates to a method and apparatus for attaching rib wires to wire screens.

### BACKGROUND

Natural resources, such as hydrocarbons or water, are obtained from subterranean reservoirs by drilling wells from the surface into such formations and subsequently providing the well with production tubing to allow the natural resources to flow to the surface. Typically, the production tubing comprises a plurality of tubular members that are secured end to end. The portion of the production tubing within the reservoir is provided with a number of ports along its length to allow inflow of, for example, hydrocarbons.

In some cases, reservoirs are found in “unconsolidated” formations, wherein the rock material is not cohesive. Wells in such formations are known to produce sand in addition to the desired hydrocarbons. The sand often collects in and plugs the tubing used to produce the hydrocarbons, the ports themselves, and/or in other tools provided on the tubing. The sand also can erode the tubing and equipment. Further, once produced with the hydrocarbons, the sand must be filtered out.

To mitigate against the above-noted problems, screens are generally used to filter out the sand at the reservoir, before it enters the tubing. Such screens, often referred to as “wire wrap screens” are provided over the ports on the tubing, or base pipe.

In many cases, wire wrap screens are formed by first providing a number of rib wires, or ribs, along the length of the pipe, with such ribs being circumferentially spaced apart on the pipe, and then spirally wrapping a straining, or screen wire over such ribs with a desired spacing there-between. Once the wire wrap is in place, welds are applied to secure it to the pipe, thereby forming a screen to cover the perforations. Such screens are generally referred to as wire wrap screens. The rib wires, or spacing wires, serve to create an annular space between the surface of the perforated pipe and the wire wrap. Such an annular space is important to ensure that a sufficient flow of fluid into the pipe is maintained.

Typically, wire wrap screens are produced in a machine that holds and orients rib wires longitudinally along the perforated pipe. The rib wires are spaced circumferentially around the pipe and the machine then wraps the screen wire around the rib wires. The screen wire is then welded to the rib wires to secure the assembly together. For this purpose, conductive inserts are commonly used, which serve to form an electrically conductive connection between the screen wire and the rib wires during a resistive welding operation.

Examples of wire wrap screens and methods of forming same are described in the following U.S. Pat. Nos. 1,808,913; 3,785,409; 4,819,722; 5,307,984; and, 6,412,564.

It is common in the art for all of the steps of manufacturing a wire wrap screen to be conducted on a single machine. As discussed above, these steps include the placement of the rib wires, wrapping the screen wire, and welding the assembly to the base pipe. As is also commonly known, the rib wires need to be generally equidistantly spaced about the circumference of perforated pipe and such rib wires also need to extend in a generally parallel orientation with respect to the longitudinal axis of the pipe. This requires a considerable amount of time, during which the wrapping and welding machine remains idle, which leads to increased time and expense.

There exists a need for a more efficient means of manufacturing wire wrap screens.

### SUMMARY OF THE DESCRIPTION

In one aspect, there is provided a method of providing and orienting rib wires on a base pipe that does not interfere with the operation of a wire wrapping machine.

In one aspect, the method described herein comprises a step of arranging and temporarily securing rib wires to a pipe prior to the pipe being placed in a wire wrap machine.

In one aspect, there is provided an apparatus for providing rib wires onto a pipe, the apparatus comprising at least one strap comprising a plurality of slots for receiving rib wires, the strap being adapted to be wrapped around the circumference of a pipe.

In one aspect, there is provided a method of providing rib wires on a pipe, the method comprising: providing a plurality of rib wires onto one or more straps, wherein the straps comprise at least one first strap having a plurality of slots for receiving first portions of the rib wires, whereby the first portions of the rib wires are provided in a generally parallel, spaced apart arrangement; and, wrapping the straps circumferentially over the pipe to secure the rib wires to the pipe.

In another aspect, there is provided a strap for providing rib wires onto a surface of a pipe, the strap comprising a plurality of generally parallel slots for receiving individual rib wires and for positioning the rib wires in a spaced apart and generally parallel arrangement; wherein the strap is adapted to engage the pipe and to arrange the rib wires generally parallel with the longitudinal axis of the pipe and generally equidistantly spaced apart over the circumference of the pipe.

In another aspect, there is provided a strap for providing rib wires onto a surface of a pipe, the strap comprising a plurality of generally parallel grooves for receiving groups of rib wires and for positioning the rib wires along the length of the pipe; wherein the strap is adapted to engage the pipe and to arrange the groups of rib wires along the longitudinal axis of the pipe.

### BRIEF DESCRIPTION OF THE FIGURES

The features of certain embodiments will become more apparent in the following detailed description in which reference is made to the appended figures wherein:

FIG. 1 is a perspective view of a first version of a strap according to an aspect of the description.

FIG. 2 is a perspective view of three straps of FIG. 1 provided with a plurality of rib wires and adapted to be mounted on a pipe.

FIG. 3 is a perspective view of the straps of FIG. 2 and a pipe placed thereon.

FIG. 4 is a perspective view of the arrangement of FIG. 3, after the straps have been wrapped around the pipe.

FIG. 5 is a perspective view of a pipe of FIG. 4 further having a collet secured thereon.

FIG. 6 is a front view of an insert provided on the collet.

FIG. 7 is a top front perspective view of the insert of FIG. 6.

FIG. 8 is a partial perspective view of a pipe of FIG. 4 further having a collet with inserts secured thereon.

FIG. 9 is a cross-sectional view of the assembly shown in FIG. 8.

FIG. 10 is a perspective view of the entire pipe shown in FIG. 8.

FIG. 11 is a partial perspective view of the pipe shown in FIG. 8 loaded into a wire wrap machine.

FIG. 12 is perspective view of a second version of a strap according to another aspect of the description.

FIG. 13 is a perspective view of an arrangement of rib wires within first and second versions of the straps.

FIG. 14 is a perspective view of the arrangement of rib wires and straps of FIG. 13 in combination with a pipe.

### DETAILED DESCRIPTION

As used herein, the term “pipe” or “base pipe” will be understood to mean a pipe segment that is combined with other pipe segments and inserted into a wellbore. The pipe will normally have a plurality of perforations at at least one section thereof. A wire wrap screen is provided over the perforated section(s) of the pipe.

As used herein, the term “rib wire” will be understood to mean a wire or rib that is provided longitudinally along the outer surface of the pipe. The rib wires form part of the wire wrap screen that is provided on a pipe.

As used herein, the term “straining wire” or “screen wire” will be understood to mean a wire that is spirally wrapped over the rib wires. The screen wire is wrapped in such a manner as to provide a desired space between each revolution. The screen wire in combination with the rib wires form a wire wrap screen.

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

Described herein is a method and apparatus for temporarily securing rib wires of a wire wrap screen to the outer surface of a pipe prior to wrapping the rib wires with a screen wire. With the described method and apparatus, rib wires are at least temporarily secured to a pipe in a desired orientation prior to placement within a wire wrapping and welding machine. In this way, the machine can continue to wrap rib wires with a screen wire while rib wires are temporarily secured to a second pipe, separately from the machine. The second pipe can then be immediately positioned on the machine and the wire wrap procedure can be commenced and continued without interruption. In this manner, the wrapping process can proceed continuously without having to be paused for placing and/or orienting rib wires. As a result, a greater number of wire wrap screens can be provided on pipes in a shorter amount of time.

Once the screen wire is welded to the rib wires to form the wire wrap screen, the screen may then be secured to the pipe in any manner. For example, as known in the art, end rings can be provided over the pipe and positioned on opposite ends of the wire wrap screen. Such end rings may then be welded to the pipe as is commonly known. Alternatively, instead of applying welds to the pipe, the wire screen formed according to the present description may be secured to the pipe using a method as described in applicant's co-pending application No. 62/404,046, the entire disclosure of which is incorporated herein by reference.

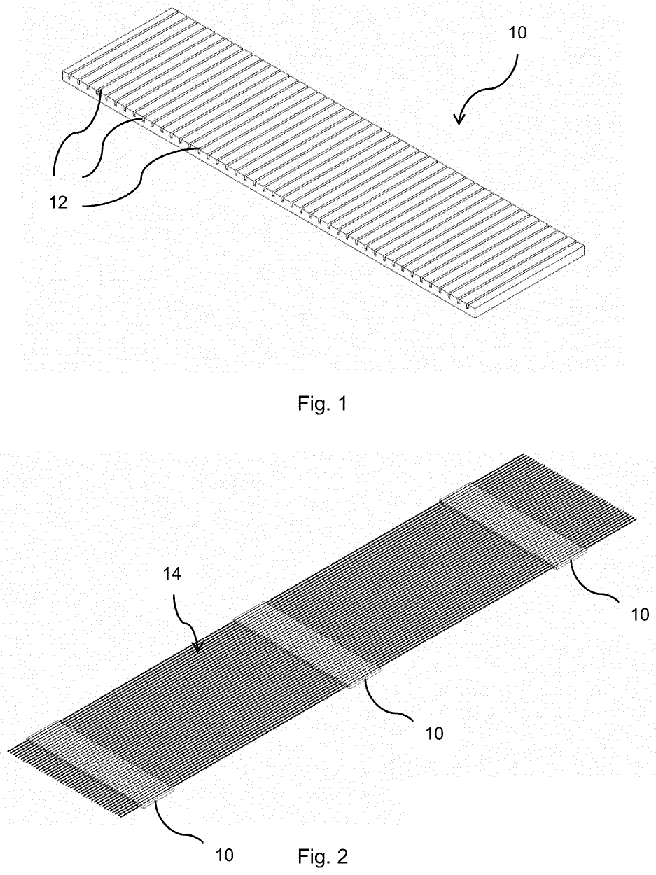

As shown in FIGS. 1 to 3, according to one aspect of the description, one or more straps 10 (also referred to herein as “first straps”) are provided, each of the straps 10 including a plurality of slots 12, which are adapted to receive rib wires therein. Typically, at least two of such straps 10 are utilized for a given pipe, and sometimes more, as would be understood by persons skilled in the art having reviewed the present description.

The straps 10 are preferably flexible, wherein they are able to initially be provided in a flat arrangement as shown in FIG. 1. As will be understood, while the straps are in such flat orientation, the placement of rib wires within the slots 12 is facilitated. FIG. 2 illustrates two straps, in a flat arrangement, onto which a plurality of rib wires 14 is provided.

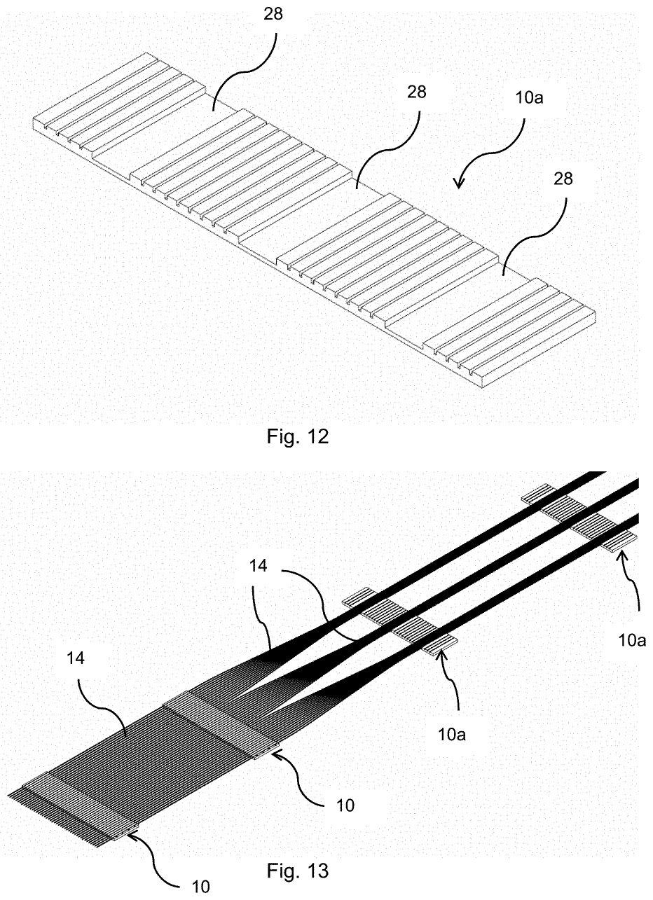

As can be seen in the straps shown in FIGS. 1 and 2, the slots 12 are generally arranged in an evenly spaced apart manner, whereby each of the rib wires 14 is separated from an adjacent rib wire by generally the same distance. In another aspect, such as shown in FIG. 12, the strap as shown at 10a may be provided with a number of sections comprising wide slots. This version of the strap is discussed further below.

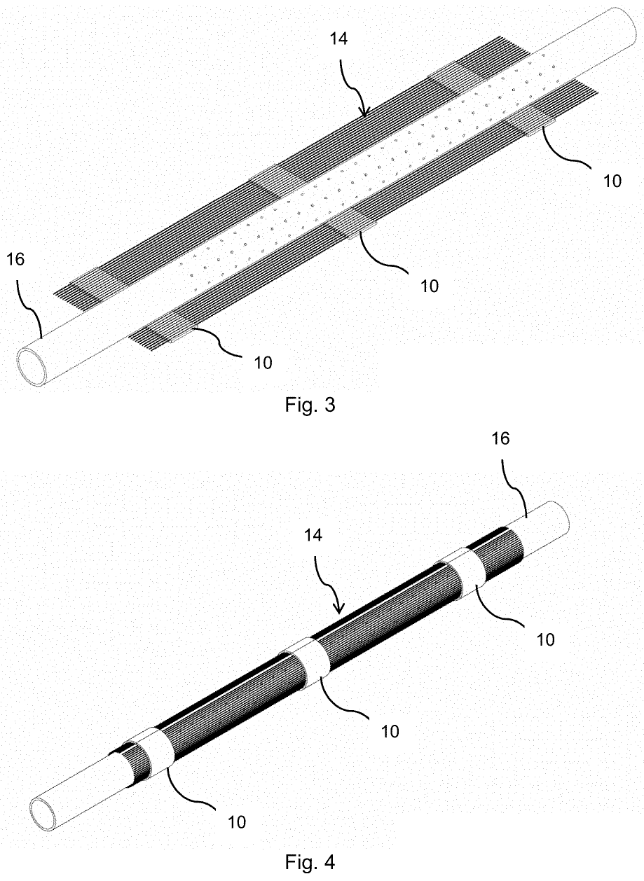

As shown in FIG. 3, once the required number of rib wires 14 are provided within the slots 12 of the straps 10, a pipe 16 is provided thereon.

FIG. 4 illustrates the straps 10 after have been wrapped around the pipe 16. As will be noted, once the straps 10 are wrapped, the rib wires 14 are generally evenly distributed around the circumference of the pipe 16 and also generally axially aligned therewith. In other words, the rib wires 14 are positioned about the pipe in the desired manner.

As indicated above, the straps 10 are flexible to allow them to be wrapped around the circumference of the pipe as described above. To achieve this, the straps can be made of any appropriate material or may have any appropriate structure to enable such wrapping to occur. For example, in one aspect, the straps 10 may be made of a rubber material.

The straps also preferably include a means of being secured to the pipe 16. For example, in a preferred aspect, the straps 10 may be made of a magnetized rubber material, or a rubber material into which magnets are provided or embedded. As will be understood, with such a magnetized material, the rib wires 14 would be held in place while the straps are manipulated and, further, that the straps can be easily secured to the pipe 16, along with the rib wires, once the straps are wrapped around the pipe. In addition, with rubberized and magnetized straps, a pipe can be laid over one end of the straps and then simply rolled there-over in order to allow the straps to be wrapped in a more efficient manner.

In other aspects, the straps 10, while being made of a flexible material, can be secure to the pipe 16 in other ways, such as with one or more fasteners; e.g. hook and loop fasteners; hooks, snaps, etc. It will be appreciated that the present description is not limited to any particular method of securing the straps to the pipe 16.

In other aspects, the straps 10 may be made of a series of sections that are linked together in a hinged arrangement. Such arrangement would allow the straps to be laid flat when receiving the rib wires and then to be wrapped around a pipe. Even with this structure, the straps can be provided with any type of securing means, such as magnets, hooks, snaps etc., to enable them to be wrapped around a pipe.

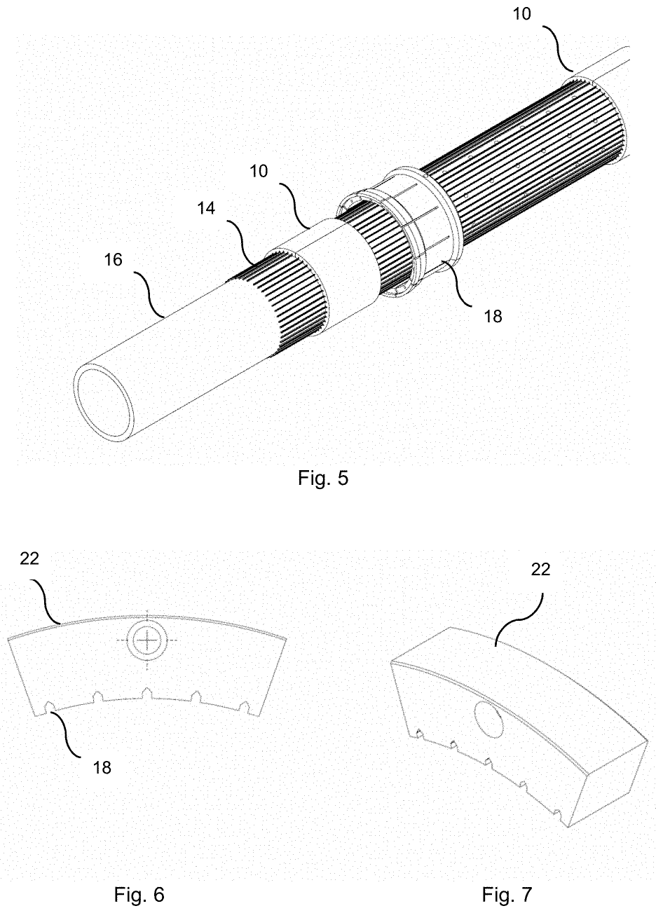

As shown in FIG. 5, once the pipe 16 is provided with the straps 10 and rib wires 14, a collet 18 is placed over the pipe 16. As would be understood, the collet serves to engage the pipe 16 in preparation for the wire wrap process (as discussed further below). The collet 18 may be secured to the pipe 16 by any suitable means, such as with clamps etc., as would be known to persons skilled in the art.

Preferably, a collet centralizer 20 is also provided to assist in the positioning of the collet 18 on the pipe 16.

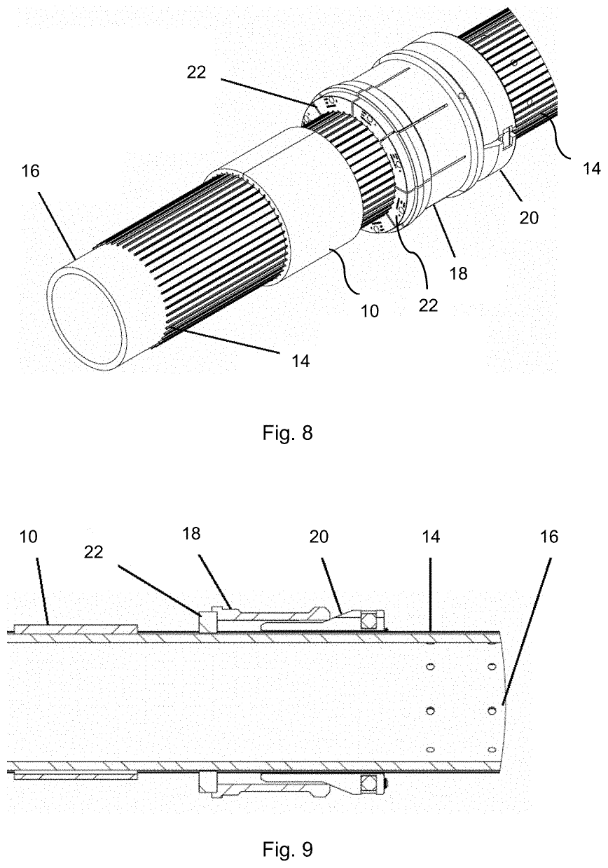

In one aspect, as shown in FIG. 8, the collet 18 is preferably provided with a plurality of circumferentially spaced inserts on a first end thereof. As shown in FIGS. 6 and 7, such inserts are provided with a number of grooves 24 that are adapted to receive the rib wires 14. Once the collet 18 is secured to the pipe, the inserts are then secured to the collet 18, whereby rib wires 14 are individually received in respective grooves 24. As shown in FIG. 8, in this manner, the circumferential spacing of the rib wires 14 with respect to the pipe 16 is maintained. FIG. 9 shows a cross section of the arrangement illustrated in FIG. 8.

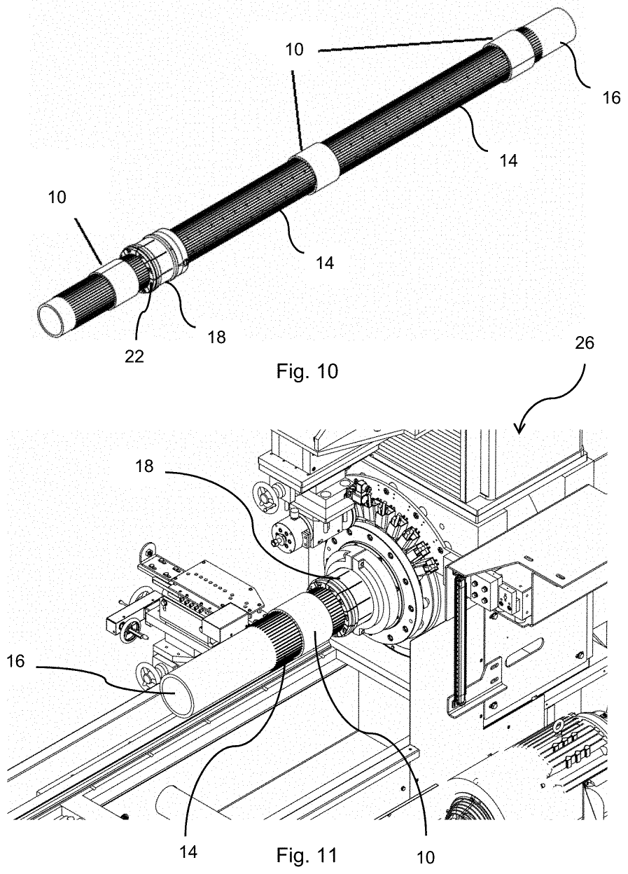

FIG. 10 shows the pipe 16 of FIG. 8 in its entirety. In the example shown, the pipe 16 is provided with three straps 10 which assist the collet 18 and inserts 22 in maintaining the rib wires 14 in the required circumferential spacing over the surface of the pipe in preparation for the wire wrap process.

As illustrated in FIG. 11, with the rib wires 14 and collet 18 secured to the pipe 16, in the manner shown in FIG. 10, the combined assembly is secured into a wire wrap machine 26. Such wire wrap machines are well known in the art. In particular, the machine includes an opening through which the pipe is inserted. Once the pipe is in place, the collet 18 is secured to the wire wrap machine 26 as known in the art and as shown in FIG. 11. At this point, the wire wrap process is begun by feeding a screen wire (not shown) circumferentially over the rib wires 14. During this process, the pipe 16 and rib wires 14 are drawn through the wire wrap machine, whereby the screen wire is provided over the rib wires 14 in a spiral arrangement, with each rotation of the spiral being separated from the previous rotation by any desired distance. As would be understood, such separation is dependent upon the speed at which the pipe is drawn through the wire wrap machine. In the drawing the pipe 16 through the wire wrap machine 26, each of the straps 10 is removed as it approaches the wire wrap machine.

The wire wrap machine 26 also secures the screen wire to the rib wires 14. Generally, this is done using welds at certain locations to secure the screen wire to the rib wires 14. In one aspect, and as discussed above, the inserts 22 may be made of a conductive material to facilitate the welding of the screen wire to the rib wires where a resistive welding process is used.

The wire wrap machine 26 provides the screen wire over the rib wires 14 in the proximity of the inserts 22. As discussed above, the inserts 22 provided on the collet 18 include a number of grooves 24 that are designed or adapted to engage individual rib wires 14. Thus, as the pipe 16 and rib wires 14 are drawn through the collet and the wire wrap machine 26, the grooves 24 on the inserts 22 ensure that the rib wires 14 are in the desired position over the pipe 16. For this reason, it will be understood that it may not be necessary to hold the rib wires 14 in the manner as shown in FIG. 10 upstream of the wire wrap machine 26. That is, as long as the rib wires 14 are able to be drawn through the inserts 22, the grooves 24 will ensure that that the rib wires 14 are properly positioned over the surface of the pipe 16 as the screen wire is provided there-over. Thus, it may sometimes be sufficient if the rib wires 14 upstream of the wire wrap machine are only generally provided in desired positions. For this purpose, FIG. 12 illustrates another aspect of the strap of the description (also referred to herein as a “second strap”) as shown at 10a. As can be seen, the strap 10a includes a number of wide groove sections 28, that are adapted to receive a plurality, or a bundle, of rib wires.

As further illustrated in FIG. 13, strap 10a allows the rib wires 14 to be grouped or bundled together instead of being arranged within individual slots. In the arrangement shown, a number of first straps 10 are provided, which, as described above, include slots 12 to accommodate individual rib wires. In the illustrated embodiment, two such first straps 10 are provided. As also illustrated in FIG. 13, the first straps 10 are provided close to first ends of the rib wires 14. In addition, a number of second straps 10a are provided along the lengths of the rib wires, opposite from the first ends thereof. As discussed above, the grooves 28 of the second straps 10a are adapted to receive groups or bundles of rib wires 14. As illustrated in FIG. 13, the combination of first and second straps, 10 and 10a, allow one of the ends of rib wires 14 to be received within slots 12 of the first straps 10, and arranged in an individually spaced apart manner as discussed above, while the remaining portions of the rib wires 14 are gathered into bundles and received within respective groove sections 28 of the straps 10a.

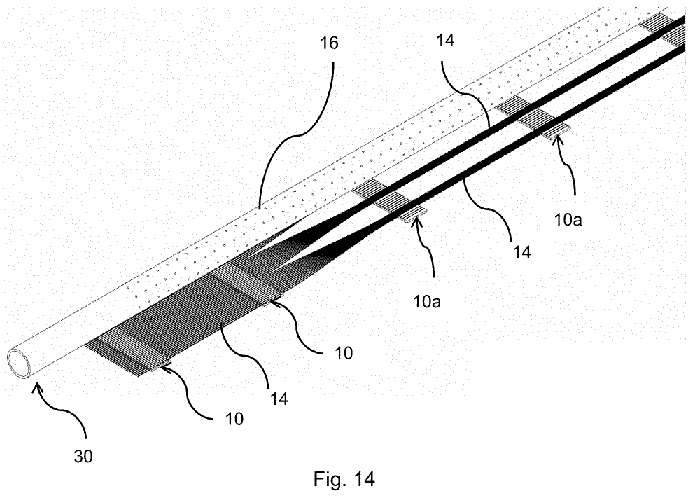

As shown in FIG. 14, once the rib wires 14 are arranged in the manner shown in FIG. 13, a pipe 16 may then be provided over the straps and the arranged rib wires. In a similar manner as described above, once the pipe is in this position, the straps 10 and 10a are wrapped around the circumference of the pipe. In this way, a region of the pipe 16 proximate to the first end 30 thereof would be provided with rib wires extending longitudinally and with the wires being circumferentially spaced over the surface of the pipe in the desired manner. As would be understood, the arrangement of the rib wires at this region of the pipe would be generally the same as that shown for example in FIG. 4.

Once the straps 10 and 10a are secured, a collet is provided over the pipe 16 in the same manner as described previously; however, in this case, the collet is provided proximal to the first end 30 of the pipe 16, where the rib wires are held in place by the first straps 10. Following securing of the collet, the pipe is then inserted into a wire wrap machine and the application of the screen wire is commenced as discussed above. As will be understood, although portions of the rib wires 14 secured with the second straps 10a are arranged in groups, as the pipe 16 is drawn through the collet the inserts 22 will ensure that the desired circumferential spacing of the rib wires 14 is achieved prior to application of the screen wire. As will also be understood, the use of the second straps 10a further improves the efficiency of the rib wire application process since only a portion of the rib wires need to be individually arranged (that is, the portions proximal to the first end of the pipe). In this way, even less time would be required for arranging and securing the rib wires.

It will be understood that any number of straps 10 and/or 10a may be provided. In some cases, the number of straps may be determined by the lengths of the rib wires or the pipe onto which the rib wires are to be secured. Further, it will be understood that the size of the straps may also vary in width and length. The present description is not limited to any number or size of the straps.

As will be understood, the purpose of the straps 10 and/or 10a is to temporarily secure rib wires onto a pipe to assist in feeding the pipe and rib wire assembly into a wire wrap machine. That is, as described above, the straps are removed as the pipe is drawn through the wire wrap machine. In this way, the straps may be reused as needed.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A method of providing rib wires on a pipe, the method comprising:
providing a plurality of rib wires onto one or more straps, wherein the straps comprise at least one first strap having a plurality of slots for receiving first portions of the rib wires, whereby the first portions of the rib wires are provided in a generally parallel, spaced apart arrangement; and,
wrapping the straps circumferentially over the pipe to secure the rib wires to the pipe.

2. The method of claim 1, wherein the first portions of the rib wires are arranged generally parallel with the longitudinal axis of the pipe and generally equidistantly over the circumference of the pipe.

3. The method of claim 1, wherein at least one of the one or more straps comprises at least one second strap having a plurality of grooves for receiving groups of rib wires.

4. The method of claim 3, wherein the second strap is positioned along the lengths of the rib wires opposite to the first portions of the rib wires.

5. The method of claim 1, wherein the straps are adapted to be temporarily secured to the pipe.

6. The method of claim 5, wherein the straps magnetically engage the pipe.

7. The method of claim 1 further comprising providing a collet over the rib wires and the pipe, wherein the collet is provided proximal to the at least one first strap.

8. The method of claim 7, wherein the collet includes a plurality of inserts and wherein the inserts include grooves for receiving individual rib wires.

9. The method of claim 1 further comprising spirally wrapping a screen wire over the rib wires.

10. The method of claim 9 further comprising securing the screen wire to the rib wires to form a wire wrap screen.

11. The method of claim 10, wherein the screen wire is welded to the rib wires.

12. The method of claim 10 further comprising securing the wire wrap screen to the pipe.

13. A strap for providing rib wires onto a surface of a pipe, the strap comprising a plurality of generally parallel slots for receiving individual rib wires and for positioning the rib wires in a spaced apart and generally parallel arrangement; wherein the strap is adapted to engage the pipe and to arrange the rib wires generally parallel with the longitudinal axis of the pipe and generally equidistantly spaced apart over the circumference of the pipe.

14. The strap of claim 13, wherein the strap is adapted to be temporarily secured to the pipe.

15. The strap of claim 14, wherein the strap magnetically engages the pipe.

16. A strap for providing rib wires onto a surface of a pipe, the strap comprising a plurality of generally parallel grooves for receiving groups of rib wires and for positioning the rib wires along the length of the pipe; wherein the strap is adapted to engage the pipe and to arrange the groups of rib wires along the longitudinal axis of the pipe.

17. The strap of claim 16, wherein the strap is adapted to be temporarily secured to the pipe.

18. The strap of claim 17, wherein the strap magnetically engages the pipe.
